(19) United States
(12) Patent Application Publication
(10) Pub. No.: US 2004/0189607 A1
(43) Pub. Date: Sep. 30, 2004

(54) Input device for electronic data storage and/or transmission apparatus

(76) Inventor: Aleksey Vladimirovich Afanasiev, Novosibirsk (RU)

Correspondence Address: Maria Nilova, 58, Moika Embankment, Office 501, St. Petersburg, RU

(21) Appl. No.: 10/772,275

(22) Filed: Feb. 6, 2004

Related U.S. Application Data
(63) Continuation-in-part of application No. PCT/RU01/00504, filed on Nov. 14, 2001.

(30) Foreign Application Priority Data
Nov. 6, 2001 (RU) 2001121807

(51) Int. Cl. G09G 5/00

(52) U.S. Cl. 345/168

(57) ABSTRACT

Claimed is an input device for an electronic data storage and/or transmission apparatus, e.g. a mobile telephone. The input device comprises a keyboard having keys corresponding to numerals inputted by stroking a respective key. The keyboard can be used for inputting other characters, e.g. letters of an alphabet, by combination strokes. The keyboard surface comprises areas on which the user's finger shall be placed when stroking a key or a combination of keys, wherein each of these keyboard surface areas corresponds to a character to be inputted. The arrangement of these areas can correspond to that of a computer keyboard, e.g. QWERTY keyboard.

### BACKGROUND OF THE INVENTION

1. Field of the Invention

The present invention generally relates to electronic data storage and/or transmission apparatus. In particular, it relates to input devices for the electronic data storage and/or transmission apparatus.

2. Description of the Prior Art

At present the electronic data storage and/or transmission apparatus are widely used. An example of a data storage and/or transmission apparatus is mobile telephone which, except their communications function, may be used for storage and/or transmission of textual data. More specifically, mobile telephones may be used as an electronic address book, as sending and receiving means for e-mail and SMS-messages and as means to access Internet. A data storage and/or transmission apparatus has an input device comprising a keyboard or keypad for typing numerals and characters such as letters and punctuation marks and for inputting them into memory and/or data transmission device of the apparatus. Usually, the keys of such a keyboard have respective numerals and letters represented thereon. (It shall be noted that the term “key” implies not only a mechanical element, which due to a movement under a mechanical force, causes a respective circuit to be connected or disconnected, but also a sensitive surface area upon touching which a respective signal is generated.) The keys of input devices of the above type are generally disposed in three rows, four keys in each row, so as to form generally rectangular configuration which may have some distortion owing to a design and a style of the apparatus. Generally, the first row comprises keys for inputting the numerals “1”, “4” and “7” and a functional key on which the character “*” is represented, the second row comprises keys for inputting the numerals “2”, “5”, “8” and “0”, and the third row comprises keys for inputting the numerals “3”, “6” and “9” and a functional key on which the character “#” is represented. Hereinafter in the disclosure the key for inputting the numeral “1” is referred as the key “1”, the key for inputting the numeral “2” is referred as the key “2”, the key for inputting the numeral “3” is referred as the key “3”, etc. As a rule, such telephones have a display for displaying the inputted data.

Known are various methods in which the keys of the above input devices for inputting numerals can also be used for inputting characters including letters and punctuation marks for inputting textual data. Generally, to input such a character, the user shall repeatedly stroke a respective key at certain intervals.

One of the most common methods of typing textual data in such input devices is as follows. Each of the keys “2”, “3”, “4”, “5”, “6” and “8 inputs three respective letters of the Latin alphabet, and each of the keys “7” and “9” inputs four respective letters of the Latin alphabet. For example, the letters “A”, “B” and “C” can be inputted with the key “2”, and the letters “P”, “Q”, “R” and “S” can be inputted with the key “7”. Other characters, e.g. punctuation marks, can be inputted by means of the rest of the keys. As a rule, basic characters to be inputted by means of the keys are represented on the keys. The whole list of characters assigned to a key can be displayed on the display of the apparatus when this key is stroked. Repeated key strokes mark out, one by one, characters in the list. For instance, the characters “2”, “A”, “B” and “C” are successively marked out by repeatedly stroking the key “2”.

In view of a rather large amount of characters used in modern texts, multiple strokes of one key are required for inputting some of the characters. For instance, to input the character “)” (the right parenthesis) in some models of mobile telephones the user has to make fifteen strokes of the key “1”. An unduly long pause between the strokes (which can occur accidentally, when the user is peering at the current character displayed on the screen), will be identified by the input device as an indication that the desired character is chosen and, instead of the desired character, the last selected character will be inputted. In this case the user will have to delete the wrong character and restart the process of selection. On the other hand, if the user is in a hurry stroking keys when selecting a character, he may step over the desired character in the list. Conventional input devices are generally not provided with a feature of returning to the previous character, and the user again has to restart the process of selection. Thus, this method of typing textual data is rather time-consuming (because, to select the desired character, the user has to make multiple keystrokes) and requires much concentration from the user.

The so-called T9 system is rather widely used in mobile telephones. This system accelerates data input by using a built-in software incorporating a dictionary and/or some grammar rules (see, e.g. U.S. Pat. No. 5,797,098, Int. class H04M 11/00, H04Q 7/00, 1998). At a keystroke, this software analyses the inputted text and suggests the character (chosen from the characters assigned to this key) that is most likely to the inputted. For example, when the combination of letters “telephon” is inputted and displayed, and the key “3” inputting either“D”, “E” or “F” is stroked, the software proposes “E” as the most presumable for completing the word “telephone”. However, with this input device the user, after each keystroke, has to check if the character proposed by the system is right, and take certain steps if it is not right. Another drawback of T9 is that it does not help in inputting proper names. Also used in the art is a similar system known as iTAP.

U.S. Pat. No. 6,111,948, Int. class H04M 1/00, 29.08.2000, discloses an apparatus for generating a signal indicative of a character in response to the path of a user's input at a touch-sensitive element. In this apparatus the path of the user's input is detected, and in response to this detection a signal indicative of a character is generated. The signal may be received by an associated electronic device. However, only a limited number of characters may be inputted by means of this apparatus because some letters may be misinterpreted by the apparatus or detected as numerals.

Other attempts to improve data input in an apparatus of the above type would usually increase the number of keys or involve touch-sensitive displays, resulting in a more complex apparatus of greater size and reduced reliability.

U.S. Pat. No. 6,073,036, Int. class H04B 1/38, 06.06.2000, discloses a touch-sensitive display displaying a telephone keypad. A first location of a tactile input is detected and displayed characters in the vicinity of the first location of the tactile input are magnified to occupy a larger display area. This input device will probably facilitate dialing telephone numbers, not inputting textual data.

### BRIEF SUMMARY OF THE INVENTION

The object of the present invention is to provide a user of an electronic data storage and/or transmission apparatus such as mobile telephone with a device which:

allows accelerated inputting of textual data without any substantial structural modification of the apparatus;

is based on traditional method of inputting information into portable or mobile devices, i.e. typing with one finger (a finger hereinafter will mean any finger or thumb); and

allows the user to employ his typing skills.

This object is achieved by providing an input device of an electronic data storage and/or transmission apparatus, which input device comprises a keyboard, and in which input device a correspondence is established between the keys of the keyboard and numerals from “0” to “9”, and another correspondence is established between the keys of the keyboard and characters of a plurality of characters including alphabet letters, the input device being adapted to input the numerals by stroking the keys and adapted to input the characters by stroking at least some of the keys, wherein said input device comprises means for inputting at least one of said characters by a combination keystroke of at least two adjacent keys of the keyboard.

Using these means in the input device according to the present invention will allow inputting a character, such as an alphabet letter, by a combination keystroke of at least two adjacent keys, thus accelerating the input of textual data. Thus, the input device according to the present invention can be implemented without any substantial structural modification of the apparatus (mobile telephone), while the data input is based on the usual methods of using this apparatus, i.e. typing with one finger. It shall be noted that in practice the user cannot stroke two or more keys absolutely simultaneously. Thus, the term “combination keystroke” or “simultaneous keystroke” in practice means that one of the keys is stroked first, and this stroke indicates the starting point of the combination, and then another key is stroked or other keys are stroked. Further, the end of the combination keystroke shall also be indicated. Thus, all keys stroked before any of them is released can be detected by the device as a combination. In other words, “simultaneously stroking” two keys will mean here that the second key is stroked earlier than the first key is released. Similarly, simultaneously stroking three keys will mean here that the third key is stroked earlier than the first or second key is released. Such a keystroke is similar to a combination keystroke using [Shift], [Ctrl] and [Alt] on a computer keyboard. Alternatively, a period of time after the first key is stroked can be preset during which all stroked keys are detected by the device as a combination.

In the input device according to the present invention a correspondence between pairs, triples or quaternaries of adjacent keys and one set of characters from the plurality of characters can be established in such a way that a character of this set is inputted by simultaneously stroking two adjacent keys, three adjacent keys or four adjacent keys.

The keys of the keyboard can be arranged at least in two lines or in rows. The keyboard can comprise a first row of keys for inputting the numerals <<1>>, <<4>>, <<7>>, a second row of keys for inputting the numerals <<2>>, <<5>>, <<8>>, <<0>>, and a third row of keys for inputting the numerals <<3>>, <<6>>, <<9>>.

In the preferred embodiment of the present invention the keys are sized and configured so that the user can stroke one key, two adjacent keys, three adjacent keys or four adjacent keys with one finger. The keyboard surface therefore comprises areas on which the user's finger shall be placed when stroking a key or a combination of keys. Thus, each of these keyboard surface areas corresponds to at least one character to be inputted.

The keyboard can have such a layout and configuration that said keyboard surface areas of are arranged at least in two lines or in rows.

Since one key, e.g. key “2”, can be used in different combinations, this key shall be regarded as common for these combinations. In this context, a keyboard can have such a layout and configuration that at least three of all the characters that can be inputted by stroking combinations comprising the same common key, are situated in the alphabet one after another. This layout and configuration is similar to the above-described layout and configuration of a traditional input device wherein, e.g. the letters “A”, “B” and “C” can be inputted with the key “2”, and the letters “P”, “Q”, “R” and “S” can be inputted with the key “7”. Thus, the user accustomed to working with that input device (i.e. any user of a traditional mobile telephone) can use his skills, so that he will not need any training for immediately reaching a high speed of typing. However, in the preferred embodiment, the keyboard has such a layout and configuration that the arrangement of said keyboard surface areas generally corresponds topologically to the arrangement of character keys of a keyboard for a typewriter or computer, e.g. the QWERTY keyboard.

Topology is known as a branch of mathematics that studies patterns of geometric figures involving position and relative position without regard to size. Topology is sometimes referred to popularly as “rubber-sheet geometry” because a figure can be changed to that of an equivalent figure by bending, stretching, twisting, and the like, but not by tearing or cutting.

More specifically, topology is concerned with those properties of geometric figures that are invariant under continuous transformations. A continuous transformation, also called a topological transformation or homeomorphism, is a one-to-one correspondence between the points of one figure and the points of another figure such that points that are arbitrarily close on one figure are transformed into points that are also arbitrarily close on the other figure. Figures that are related in this way are said to be topologically equivalent.

Thus, not only does a keyboard correspond topologically to a standard keyboard when it has the same configuration of keys (or areas, as in the current embodiment), but also when this configuration is deformed, e.g. when these keys or areas form curved, e.g. arcuate lines, instead of straight lines formed by keys of a standard keyboard.

Thus, a user accustomed to working with a standard keyboard, e.g. QWERTY keyboard (i.e. any user of a normal PC) can use his skills, so that he will not need any training for immediately reaching a high seed of typing.

To facilitate the input, each said area can be marked with its corresponding character.

An input device according to the present invention can additionally comprise means for inputting at least one of the characters by successively stroking a key at least twice.

The above correspondence between the keys and the sets of the characters can be established in such a way that each of the keys corresponds to several characters to be inputted by successively stroking that key. For example, the letters “A”, “B” and “C” of the Latin alphabet can be inputted by successively stroking the key “2”, the letters “D”, “E” and “F” can be inputted by successively stroking the key “3”, the letters “G”, “H” and “I” can be inputted by successively stroking the key “4”, the letters “J”, “K” and “L” can be inputted by successively stroking the key “5”, the letters “M”, “N” and “O” can be inputted by successively stroking the key “6”, the letters “P”, “Q”, “R” and “S” can be inputted by successively stroking the key “7”, the letters “T”, “U” and “V” can be inputted by successively stroking the key “8”, and the letters “V”, “X”, “Y” and “Z” can be inputted by successively stroking the key “9”.

The electronic data storage and/or transmission apparatus can be, e.g. a mobile telephone, palm-top computer or pager.

Thus, the input device according to the present invention allows the user to quickly input a large amount of characters. In most cases, one stroke with one finger shall be made for inputting one character due to the use of combination keystrokes, i.e. simultaneously stroking with one finger adjacent keys of a device such as a mobile telephone having a limited amount of keys. Using a standard telephone set of twelve keys, all the letters of the alphabet can be inputted, each alphabet character being inputted by one combination keystroke made by one finger. When the configuration of the surface areas is similar with the configuration and layout of the traditional input device or standard keyboard, e.g. the QWERTY keyboard, a user accustomed to working with that keyboard (i.e. any user of a normal PC) can use his skills, so that he will not need any training for immediately reaching a high seed of typing.

### BRIEF DESCRIPTION OF THE SEVERAL VIEWS OF THE DRAWING

The present invention will be described below with references to the enclosed drawings, in which:

FIG. 1 schematically shows one embodiment of the input device of the electronic data storage and/or transmission apparatus in accordance with the present invention,

FIG. 2 schematically shows another embodiment of the input device in accordance with the present invention,

FIG. 3 is a perspective view of a key of the input device in accordance with the present invention, and

FIG. 4 to FIG. 10 schematically show other embodiments of the input device in accordance with the present invention.

### DETAILED DESCRIPTION OF THE INVENTION

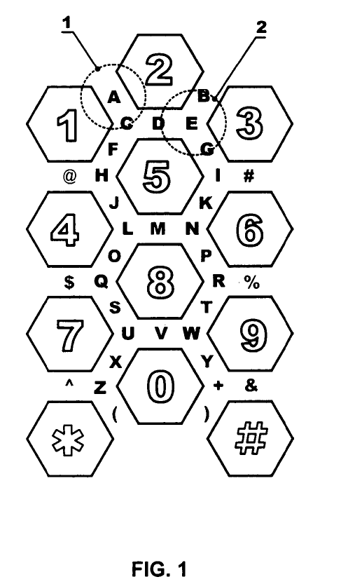

FIG. 1 schematically shows one embodiment of the input device of the electronic data storage and/or transmission apparatus, e.g. of a mobile telephone, in accordance with the present invention. This input device comprises a keyboard or keypad for typing numerals and characters such as letters and punctuation marks and for inputting them into memory or data transmission device of the apparatus. An internal arrangement of such a keyboard and processes occurring in the apparatus after a key is stroked and completed by inputting a character are not disclosed here because they are obvious for skilled persons, and do not relate to the object of the present invention.

The keyboard comprises twelve keys, ten of which are intended to input the numerals from “0” to “9” and the other two keys are the functional keys “*” and “#”. The keys, shaped as a hexagon, are spaced as a tessellation structure so as to form generally four rows, with three keys in each row, the respective numerals and characters “*” and “#” being represented on the keys. Some characters are represented on the spaces between the keys on the telephone panel. These characters can be inputted by simultaneously stroking combinations of two or three keys. These characters comprise letters of the Latin alphabet and marks “(”, “)”, “@”, “&”, “$”, “%”, “#” and “Λ”.

When inputting data, numerals are inputted by stroking respective keys. Characters for textual information are inputted by simultaneously stroking a combination of two or three keys. For example, letter “A” is inputted by a combination stroke of the keys “1” and “2”; letter “B” is inputted by a combination stroke of the keys “2” and “3”; and letter “D” is inputted by a combination stroke of the keys “2” and “5”.

Letter “C” is inputted by a combination stroke of the keys “1”, “2” and “5”; letter “E” is inputted by a combination stroke of the keys “2”, “3” and “5” and letter “H” is inputted by a combination stroke of the keys “1”, “4” and “5”. The keyboard of FIG. 1 uses the Latin alphabet. It shall, however, be noted that the present invention may well be adapted for inputting texts in Cyrillic or other alphabets.

As stated above, in a “combination keystroke” one key is stroked first, which action is an indication of the start of the combination in which another key is stroked or other keys are stroked. Thus, when two keys are involved, a “combination keystroke” means that the second key is stroked earlier than the first key is released.

It is significant that a “combination keystroke” of two or three adjacent keys can be effected with one finger. For this purpose the user shall place a finger on an area of the keyboard surface which includes a part of the surface of the keys comprising the combination and a space (spaces) between these keys, and stroke this area. Two of said areas are shown by dotted lines in FIG. 1 as an illustration. It shall be understood that for different users these areas can vary in shape and dimensions because each user has finger-marks of individual shape and dimensions. For simplicity, however, these areas are presented as circles of average size.

Area 1 comprising a part of the surface of the keys “1” and “2” and a space therebetween corresponds to the letter “A” to be inputted. In other words, this area is for placing the user's finger when stroking a combination of the keys “1” and “2”. Therefore, the letter “A” is inputted by this combination stroke.

Area 2 comprising a part of the surface of the keys “2”, “3” and “5” and spaces therebetween corresponds to the letter “E” to be inputted. In other words, this area is for placing the user's finger when stroking a combination of the keys “2”, “3” and “5”. Therefore, the letter “E” is inputted by this combination stroke.

As shown in FIG. 1, to facilitate data input, each said area is marked with its corresponding character. For instance, area 1 is marked with “A”, and area 2 is marked with “E”.

For ease of data input, the representations of the characters to be inputted by a three-key combination stroke, e.g. “C”, “E”, “H” and “I” are set off (presented in black) so that they may be distinguished from the characters (“A”, “B”, “D”, “F”, “G”, etc.) to be inputted by a two-key combination stroke. Obviously, they can be set off in any other way, e.g. by changing color and/or size of these characters or their background.

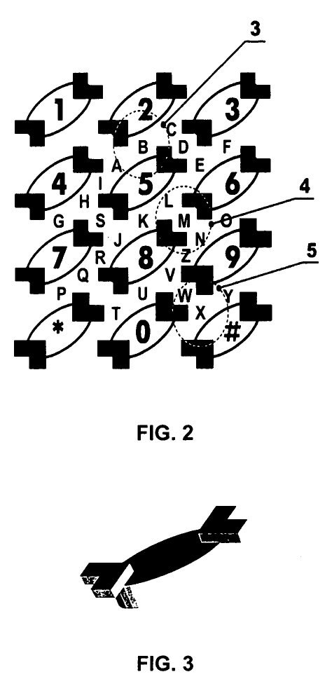

FIG. 2 shows another embodiment of the input device in accordance with the present invention. In the keyboard of this device the keys, being the same in number as the keys presented in FIG. 1, however, differ in their shape and arrangement. Also, the arrangement of said marked areas is different. The keys are generally in the form of an oval positioned at an angle to the longitudinal axis of the keyboard. Thus, the keys form diagonal rows.

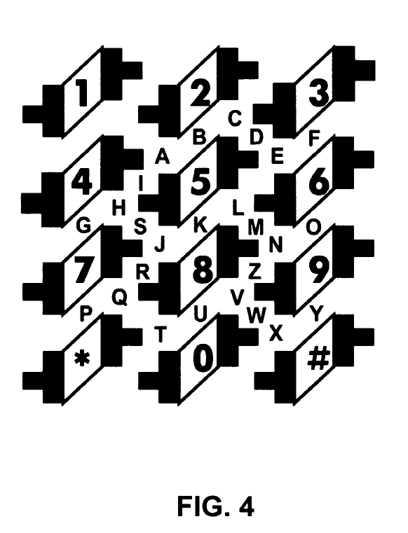

The keyboard of FIG. 2 also comprises marked areas for locating the user's finger when stroking a combination of keys. To facilitate a keystroke, the oval sides of the keys circumscribed by the minor radius have rectangular projections projecting both outside the oval periphery of the keys and above their surface. A perspective view of a single key with these projections is shown in FIG. 3. Projections on adjacent keys face each other and form a platform which has a discontinuity constituted by the space between the keys, and which is thus easy to sense for and stroke with one finger.

In FIG. 2, as in the previous drawing, some of said marked areas are shown, by way of example, in dotted lines.

Area 3 corresponding to the letter “B” is for placing the user's finger when stroking a combination of the keys “2” and “5”. The letter “B” is inputted by this combination stroke.

Area 4 corresponding to the letter “M” is for placing the user's finger when stroking a combination of the keys “8” and “6”. The letter “M” is inputted by this combination stroke.

Area 5 corresponding to the letter “X” is for placing the user's finger when stroking a combination of the keys “0”, “9” and “#”. The letter “X” is inputted by this combination stroke.

As shown in FIG. 2, the keyboard has such a layout and configuration that at least three of all the characters corresponding to those of said keyboard surface areas, said key combination of which comprises a common key, are situated in the alphabet one after another. For instance, “A” is inputted by combination of “2”, “4” and “5”; “B” is inputted by combination of “2” and “5”; and “C” is inputted by combination of “2”, “3” and “5”. Thus, all these combinations include the key “2”. It is easy to see that “A”, “B” and “C” follow each other in the alphabet. This layout and configuration is similar to the above-described layout and configuration of a traditional input device wherein, e.g. the letters “A”, “B” and “C” can be inputted with the key “2”, and the letters “P”, “Q”, “R” and “S” can be inputted with the key “7”. Thus, the user accustomed to working with that input device (i.e. any user of a traditional mobile telephone) can use his skills, so that he will not need any training for immediately reaching a high seed of typing.

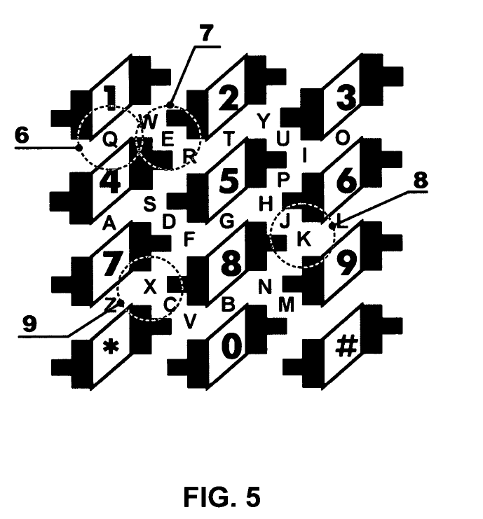

A keyboard shown in FIG. 4 is generally the same as that shown in FIG. 2 but differs in the shape of the keys which are generally in the form of a rhombus, and in the shape of projections which are T-shaped. Projections on adjacent keys face each other and form a platform which has a discontinuity constituted by the space between the keys, and which is thus easy to sense for and stroke with one finger. Characters are inputted by means of this keyboard in the same way as disclosed with respect to the keyboard of FIG. 2.

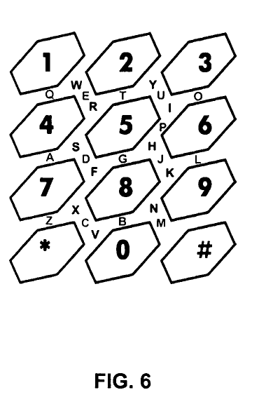

A keyboard of FIG. 5 has the same configuration of keys as the keyboard of FIG. 4. However, combinations for inputting characters are different. Therefore, said marked areas are also arranged in a different way. The configuration of said marked areas generally corresponds to that of the character keys of a standard typewriter keyboard or computer keyboard in which the first six keys in the upper row are “Q”, “W”, “E”, “R”, “T” and “Y” (the so-called QWERTY keyboard). The only exception is the letter P that is slightly offset.

As shown in FIG. 5, unlike the keys of the standard keyboard located in three straight horizontal rows, the marked areas are offset with respect to each other. However this arrangement of the areas can be transformed to three straight horizontal rows by means of a topological transformation already defined above. Thus, the arrangement of the marked areas on the keyboard of FIG. 5 corresponds topologically to the arrangement of the keys of standard QWERTY keyboard. Thus a user accustomed to working with QWERTY keyboard (i.e. any user of a normal PC) can use his skills, so that he will not need any training for immediately reaching a high seed of typing.

In FIG. 5, as in the previous drawings, some of said marked areas are shown, by way of example, in dotted lines.

Area 6 corresponding to the letter “Q” is for placing the user's finger when stroking a combination of the keys “1” and “4”. The letter “Q” is inputted by this combination stroke.

Area 7 corresponding to the letter “E” is for placing the user's finger when stroking a combination of the keys “2” and “4”. The letter “E” is inputted by this combination stroke.

Area 8 corresponding to the letter “K”is for placing the user's finger when stroking a combination of the keys “6”, “8” and “9”. The letter “K” is inputted by this combination stroke.

Area 9 corresponding to the letter “X” is for placing the user's finger when stroking a combination of the keys “7”, “8” and “*”. The letter “X” is inputted by this combination stroke.

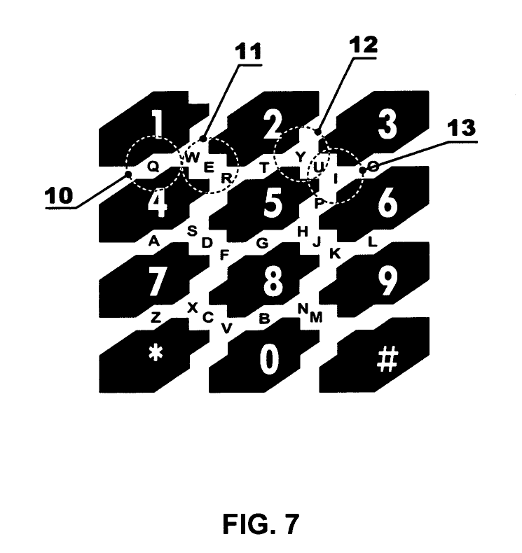

FIG. 6 shows a keyboard in which the keys are in the form of an elongated hexagon, and the arrangement of the keys and said marked areas generally corresponds to that of the keyboard of FIG. 5.

FIG. 7 shows a keyboard in which each key is shaped as an elongated polygon having recesses facing adjacent keys and respective projections located between the recesses. The arrangements of the keys and said marked areas are generally the same as that of the keyboards of FIGS. 5 and 6. The recesses and projections allow the user to place a finger on a required area more accurately and correctly. Thus, when placing a finger on area 10 for inputting the letter “Q”, it is easy to sense it between two recesses of the keys “1” and “4”, respectively. Further, when placing a finger on area 11 for inputting the letter “E”, it is easy to sense it between two recesses of the keys “2” and “4”.

When placing a finger on an area 12 for inputting the letter “Y”, the user senses three projections of the keys “2”, “3” and “5” facing each other. In the same way, when placing a finger on an area 13 for inputting the letter “I”, the user senses three projections of the keys “3”, “5” and “6” facing each other.

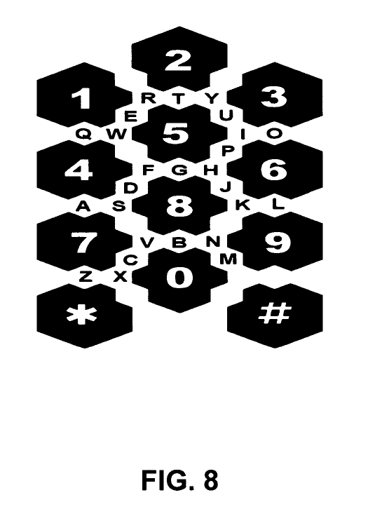

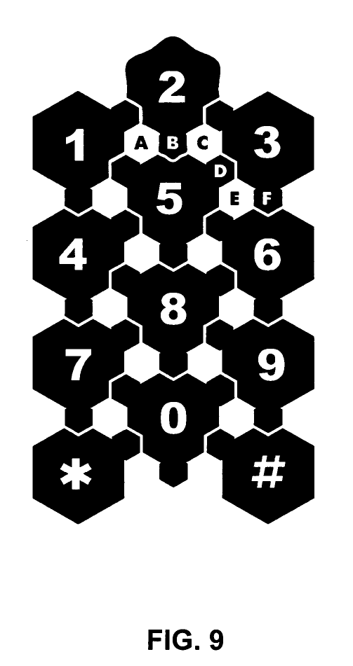

FIG. 8 shows a keyboard in which each key is shaped as an elongated polygon having recesses facing adjacent keys and respective projections located between the recesses. As indicated above, the recesses and projections allow the user to place a finger on a required area more accurately. The arrangement of the keys is generally the same as in FIG. 1, while the arrangement of said marked areas is generally the same as that of in FIGS. 5, 6 and 7. However, the arrangement of said marked areas can be as in any of the above embodiments.

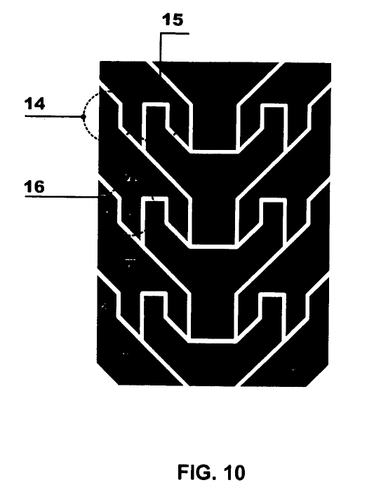

FIG. 9 shows a keyboard in which the arrangement of the keys is generally the same as that of the keyboard of FIG. 1. However, the keys of this keyboard differ from the keys shown in FIG. 1 in that they have at least one projection facing and adjoining at least one adjacent key. Thus, the projections lie in the centers of respective marked areas corresponding to combinations of two keys, so that, when stroking such a combination, the user will aim at a respective projection.

Thus, the key having this projection and the adjacent key facing the projection will be stroked. When stroking a combination of three keys, the user will aim at a hexagonal space between the keys. Thus, three keys defining this space will be simultaneously stroked. Arrangement and marking of the areas can be as in any of the above embodiments.

FIG. 10 shows a keyboard in which the keys are in the form of polygons of different shapes, the keys having projections and closely mating each other. An important feature of this keyboard is that the marked areas form three straight horizontal rows, and therefore are most similar in configuration to keys of a standard keyboard, e.g. QWERTY. In FIG. 10 some of said marked areas are shown, by way of example, in dotted lines.

Area 14 corresponding to the letter “Q” is for placing the user's finger when stroking a combination of the keys “1” and “4”. The letter “Q” is inputted by this combination stroke.

Area 15 corresponding to the letter “E” is for placing the user's finger when stroking a combination of the keys “1” and “5”. The letter “E” is inputted by this combination stroke.

Area 16 corresponding to the letter “S” is for placing the user's finger when stroking a combination of the keys “4”, “7” and “8”. The letter “S” is inputted by this combination stroke.

Within the scope and spirit of the invention, other embodiments (not illustrated) can be provided. Thus, a modified method of inputting information can be employed using an apparatus having a traditional keyboard, i.e. with a numeral and several characters associated with each key and marked thereon (or therebeside). As mentioned above, whole list of characters assigned to a key can be displayed on the display of such an apparatus when this key is stroked. Repeated key strokes mark out, one by one, characters in the list. The modified method of inputting information employed with such an apparatus, can be as follows:

The first character (i.e. a numeral) in the list of characters associated with a key is inputted by stroking this key once (or by stroking this key twice, or by stroking with retention). The second character in the list is inputted by first stroking this key, and then stroking an adjacent key in the longitudinal or lateral direction. The third character in the list is inputted by first stroking this key, and then stroking an adjacent key in the diagonal direction. The fourth character of the list is inputted by first stroking this key, and then any key that is not adjacent, or by stroking the first key twice, or by retaining the first key if these methods are not implied for other functions. Such means for inputting characters allow an amount of possible combinations and therefore, an amount of characters inputted by means of the input device according to the present invention can be increased.

The means for inputting characters according to the present invention can be combined with conventional means for inputting characters so that rapid successive keystrokes at adjacent keys or their combinations and/or a keystroke with retention for a certain time may be used on parity with the simultaneous keystroke at two or three adjacent keys. Obviously, with any above embodiment the characters can include letters of different alphabets.

With the present invention, a structural modification of a conventional telephone and its keyboard is not necessary. If the size and configuration of the keys of a conventional telephone allow the user to stroke a combination of adjacent keys by one finger, the present invention can be implemented in this apparatus by correspondingly changing a keyboard layout, i.e. only software. Further, it is evident that the present invention can be used not only in a mobile telephone but also in any electronic data storage and/or transmission apparatus, e.g. in a palm-top computer or pager.

The shapes of the keys can differ from the described shapes. The keys can be rectangular, triangular, circular, etc,. Moreover, as stated above, the upper surface of the keys can be uneven. For most comfortably and accurately stroking a combination of keys, the latter can comprise convexities and/or cavities.

I claim:

1. An input device of an electronic data storage and/or transmission apparatus, the input device having a keyboard comprising keys adapted to input numerals from “0” to “9” and some alphabetical characters, and wherein the keyboard is adapted to input remaining alphabetical characters by a combination stroke of more than one keys.

2. An input device according to claim 1, wherein the keys are sized and configured in such a way that the user can stroke two adjacent keys with one finger.

3. An input device according to claim 1, wherein the keys are sized and configured in such a way that the user can stroke three adjacent keys with one finger.

4. An input device according to claim 1, wherein the keys are sized and configured in such a way that the user can stroke four adjacent keys with one finger.

5. An input device according to claim 1, wherein the keyboard surface comprises areas on which the user's finger shall be placed when stroking a key or combination of keys, wherein each of these keyboard surface areas corresponds to at least one character to be inputted.

6. An input device according to claim 5, wherein each said area is marked with its corresponding character.

7. An input device according to claim 5, wherein the keyboard has such a layout that a plurality of combination strokes in which one common key is used, inputs a corresponding plurality characters situated in the alphabet one after another.

8. An input device according to claim 5, wherein the keyboard has such a layout and configuration that the arrangement of said keyboard surface areas corresponds topologically to the arrangement of character keys of QWERTY keyboard.

9. An input device according to claim 5, wherein the keyboard has such a layout and configuration that the arrangement of said keyboard surface areas is the same as the arrangement of character keys of QWERTY keyboard.

10. A mobile telephone having a keyboard comprising keys adapted to input numerals from “0” to “9” and some alphabetical characters, wherein the keyboard is adapted to input remaining alphabetical characters by a combination stroke of more than one keys.

11. A mobile telephone according to claim 10, wherein the keys are sized and configured in such a way that the user can stroke three adjacent keys with one finger.

12. A mobile telephone according to claim 10, wherein the keys are sized and configured in such a way that the user can stroke four adjacent keys with one finger.

13. A mobile telephone according to claim 10, wherein the keyboard surface comprises areas on which the user's finger shall be placed when stroking a key or combination of keys, wherein each of these keyboard surface areas corresponds to at least one character to be inputted.

14. A mobile telephone according to claim 13, wherein each said area is marked with its corresponding character.

15. A mobile telephone according to claim 13, wherein the the keyboard has such a layout that a plurality of combination strokes in which one common key is used, inputs a corresponding plurality characters situated in the alphabet one after another.

16. A mobile telephone according to claim 15, wherein said keyboard surface areas are arranged in the alphabetical order.

17. A mobile telephone according to claim 13, wherein the keyboard has such a layout and configuration that the arrangement of said keyboard surface areas corresponds topologically to the arrangement of character keys of QWERTY keyboard.

18. A mobile telephone according to claim 13, wherein the keyboard has such a layout and configuration that the arrangement of said keyboard surface areas is the same as the arrangement of character keys of QWERTY keyboard.

19. A mobile telephone having a keyboard comprising keys adapted to input numerals from “0” to “9”, wherein a key adapted to input a numeral is also adapted to input an alphabetical character, the keyboard is adapted to input remaining alphabetical characters by a combination stroke of more than one keys, the keyboard surface comprises areas on which the user's finger shall be placed when stroking a key or combination of keys, wherein each of these keyboard surface areas corresponds to at least one character to be inputted and the keyboard has such a layout and configuration that the arrangement of said keyboard surface areas corresponds topologically to the arrangement of character keys of QWERTY keyboard.
